(19) United States
(12) Patent Application Publication
(10) Pub. No.: US 2010/0075185 A1
(43) Pub. Date: Mar. 25, 2010

(54) FUEL CELL POWER GENERATION SYSTEM FOR PROVIDING HOT WATER TO A HOUSING

(75) Inventor: Shiroh YAMASAKI, Toyoake-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: AISIN SEIKI KABUSHIKI KAISHA, Kariya-shi (JP)

(21) Appl. No.: 12/627,887

(22) Filed: Nov. 30, 2009

Related U.S. Application Data
(62) Division of application No. 11/119,928, filed on May 3, 2005.

(30) Foreign Application Priority Data
May 12, 2004 (JP) 2004-142230

(51) Int. Cl. H01M 8/04; H01M 8/00

(52) U.S. Cl. 429/17; 429/13

(57) ABSTRACT

A fuel cell power generation system includes a plurality of fuel cells executing power generating operations by use of oxidants and fuel, a plurality of hot water storage tanks in which heat energies generated upon the power generating operations of the fuel cells are stored as hot water, a power supplying portion supplying electric energies generated by the fuel cells to plural electric energy consuming portions, a control portion controlling the power generating operations executed by the fuel cells. The control portion includes a power generation correcting device by which a standard generated power output Wa is calculated by dividing a total loading dose applied to all the fuel cells, by a total number of the fuel cells that is operated to generate power, and on the basis of heat energy storage capacities of the hot water storage tanks, the standard generated power output is corrected.

### CROSS-REFERENCE TO RELATED APPLICATIONS

This application is a Divisional of U.S. patent application Ser. No. 11/119,928, filed May 3, 2005, and is based on and claims priority under 35 U.S.C. §119 to Japanese Patent Application 2004-142230, filed on May 12, 2004. The entire contents of these applications are incorporated herein by reference.

### FIELD OF THE INVENTION

The present invention generally relates to a fuel cell power generation system that is applied to plural energy consuming portions.

### BACKGROUND

A known energy supplying system is disclosed in a patent publication number H06-131004A. Specifically, the energy supplying system calculates each amount of primary energy inputted to each energy supplying means, and the amount of energy accommodated to each other by an energy transporting means by using a linear programming so that the total input amount of the primary energy inputted to the energy supplying means becomes minimum. On the basis of the calculated amount, the energy supplying means and the energy transporting means are controlled, and energy to be consumed in an energy consuming means is supplied by the energy supplying means and the energy transporting means.

According to the known technology, the energy supplying system calculates each amount of primary energy inputted to each energy supplying means, and the amount of energy accommodated to each other by the energy transporting means by using the linear programming. On the basis of the calculated value, the energy supplying means and the energy transporting means are controlled, and energy to be consumed in an energy consuming means is supplied by the energy supplying means and the energy transporting means. However, in such configurations, work volume on such calculation by means of the linear programming becomes vast, as a result practicality of the system has been lacked.

Thus, a need exists for providing a fuel cell power generation system that can improve its practicality by means of a simple control, instead of a linear programming.

### SUMMARY OF THE INVENTION

According to an aspect of the present invention, a fuel cell power generation system comprises plural fuel cells executing power generating operations by use of oxidants and fuel, plural hot water storage tanks in which heat energies generated upon the power generating operations of the fuel cells is stored as hot water, a power supplying portion supplying electric energies generated by the fuel cells to plural electric energy consuming portions, a control portion controlling the power generating operations executed by the fuel cells, wherein the control portion includes a power generation correcting means by which a standard generated power output Wa is calculated by dividing Wload, which is a total loading dose applied to all the fuel cells, by N, which is a total number of the fuel cells that is operated to generate power, and on the basis of heat energy storage capacities of the hot water storage tanks, the standard generated power output Wa is corrected.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a schematic diagram indicating a fuel cell power generation system for a complex housing;

FIG. 2 illustrates a configurational diagram near a hot water storage tank;

FIG. 3 illustrates a flow chart indicating a control of a control portion, and

FIG. 4 illustrates a schematic diagram indicating a fuel cell power generation system for a complex housing according to the second embodiment.

### DETAILED DESCRIPTION

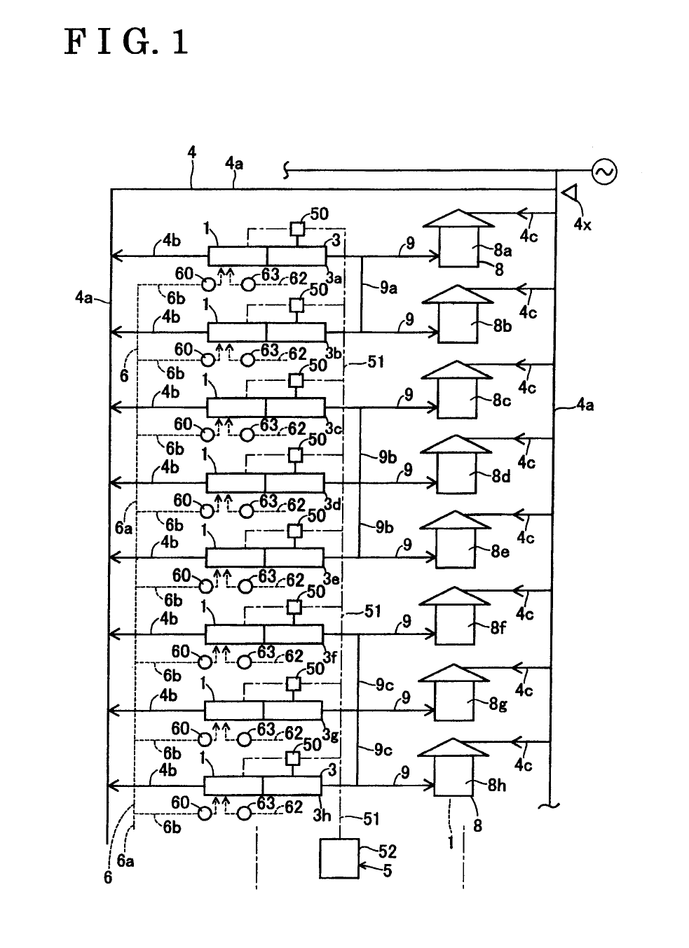

A first embodiment according to the present invention will be explained in accordance with FIGS. 1 through 3. A fuel cell power generation system for a complex housing according to the first embodiment is applied to a complex housing (e.g. a housing complex, an apartment and a residential estate), which is comprised of plural housings 8 (8a, 8b, 8c, 8d, 8e, 8f, 8g, 8h . . . ) as shown in FIG. 1. This system includes plural fuel cells 1, plural hot water storage tanks 3 (3a, 3b, 3c, 3d, 3e, 3f, 3g, 3h . . . ), an electric supply line portion 4 and a control portion 5. Specifically, the plural fuel cells 1 operates a power generation by use of an oxidant gas (oxygen-containing air) and a fuel (hydrogen-containing gas). The plural hot water storage tanks 3 (3a, 3b, 3c, 3d, 3e, 3f, 3g, 3h . . . ) store heat energy as hot water, which is generated upon the power generating operation of the fuel cells 1. The electric supply line portion 4, serving as a power supplying portion, supplies the electric energy generated by the fuel cell 1 to each of the housings 8. The control portion 5 controls the power generating operations on the plural fuel cells 1. More specifically, each of the housings 8 functions as an energy consuming portion, which consumes the electric energy generated by the fuel cells 1 or a heat energy generated by the fuel cells 1.

As shown in FIG. 1, the electric supply line portion 4 includes a common electric supply line 4a, first individual electric supply lines 4b and second individual electric supply lines 4c. Specifically, the common electric supply line 4a is commonly used in a group of the housings 8. Each of the first individual electric supply lines 4b makes a connection between each of the fuel cells 1 and the common electric supply line 4a, at the same time, each of the first individual electric supply lines 4b supplies the electric power from each of the fuel cells 1 to the common electric supply line 4a. Further, each of the second individual electric supply line 4c makes a connection between the common electric supply line 4a and each of the housings 8, at the same time, each of the second individual electric supply line 4c supplies the electric power from the common electric supply lines 4 to each of the housings 8.

Each one of the fuel cell 1 is provided for each of the housings 8, and each of the fuel cells 1 includes a hot water storage tank 3, in other words, each of the housings 8 includes one fuel cell 1 and one hot water storage tank 3. Each one of the fuel cells 1 are connected together by means of a fuel pipe 6. Specifically, the fuel pipe 6 includes a common fuel pipe 6a and distribution fuel pipes 6b. The common fuel pipe 6a is connected to the gas source, and each of the distribution fuel pipes 6b makes a connection between the common fuel pipe 6a and each of the fuel cells 1, and thus hydrogen-containing gas is supplied to a fuel electrode of each of the fuel cells 1. Each of the distribution fuel pipe 6b includes a fuel switching valve 60, and each of the fuel cells 1 includes an air pipe 62 for supplying air to an oxidant electrode of each of the fuel cells 1. Further, the air pipe 62 includes an air conveying device 63 for conveying air to the oxidant electrode of the fuel cell 1. A fan and a compressor can be used as the air conveying device 63.

Each of the water storage tanks 3 is connected to each of the housings 8 by means of a hot water supply pipe 9 in order to supply the hot water to a hot water consuming portion (e.g. a bathroom or a kitchen) in each of the housings 8. In this embodiment, the hot water storage tanks 3 are grouped in predetermined numbers. For example, a connection pipe 9a makes a connection between the hot water storage tank 3a and 3b in order to group them, a connection pipe 9b makes a connection among the hot water storage tanks 3c, 3d and 3e in order to group them, a connection pipe 9c makes a connection among the hot water storage tanks 3f, 3g and 3h in order to group them. Thus, the housings 8a and 8b can share the hot water storage tanks 3a and 3b, the housings 8c, 8d and 8e can share the hot water storage tanks 3c, 3d and 3e, and the housings 8f, 8g and 8h can share the hot water storage tanks 3f, 3g and 3h. In such circumstances, the hot water in the hot water storage tanks 3 can be shared by means of the connection pipes 9a, 9b and 9c within each of small groups of the housings 8 as mentioned above. Because the temperature of the hot water may be decreased when the hot water is conveyed away from the tank, the hot water in the hot water storage tanks 3 can be shared only by the housings 8 in neighborhood.

A control unit 5 includes individual control portions 50, an administrative control portion 52 and signal lines 51. Specifically, each of the individual control portions 50 controls the power generating operation in each of the fuel cells 1 and controls each of the hot water storage tanks 3. The administrative control portion 52 administrates each of the control portions 50 by means of each of the signal lines 51.

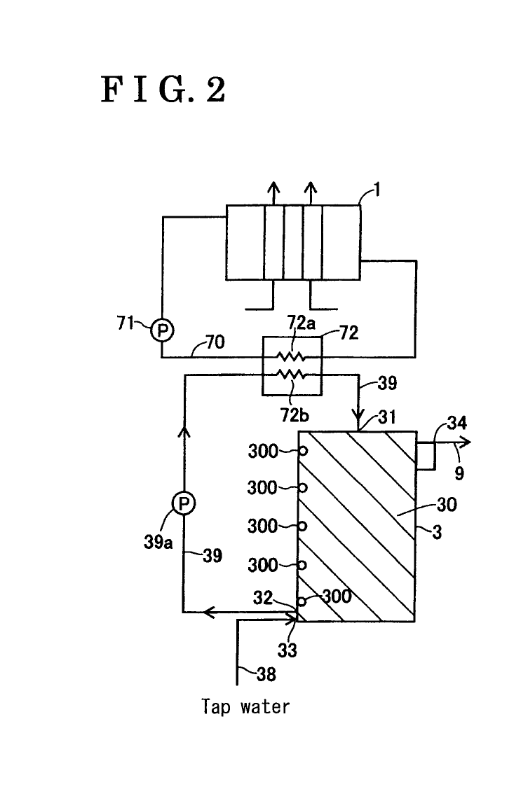

FIG. 2 illustrates a configuration diagram which indicates a vicinity of one of the hot water storage tanks 3 in which heat energy is stored as hot water, which is generated by a power generating operation in one of the fuel cells 1. As shown in FIG. 2, a coolant path 70 that has a coolant conveying device 71 (e.g. a pump means) is provided in a stuck of the fuel cell 1. Once the coolant conveying device 71 is driven, the coolant heated in the fuel cell 1 circulates within the coolant path 72 so as to pass through a heat exchange path 72a of a heat exchange device 72, and thus, overheat on the fuel cells 1 can be prevented. Further, As shown in FIG. 2, the hot water storage tank 3 includes a hot water storage chamber 30, an inlet 31 formed on the upper portion of the hot water storage tank 3, an outlet 32 formed on the bottom portion of the hot water storage tank 3, a water feeding hole 33 formed on the bottom portion of the hot water storage tank 3 and a hot water discharge outlet 34. The hot water supply pipe 9 is connected to the hot water discharge outlet 34 so as to supply the hot water to the hot water consuming portion, such as a tap of a bathtub, a shower or a tap of a kitchen sink in each of the housings 8. The water feeding inlet 33 is connected to a water feeding path 38 that is connected to a water pipe. When the hot water in the hot water storage chamber 30 is consumed, the water is supplied to the hot water storage chamber 30 through the water feeding path 38, and thus, the level of the water in the hot water storage chamber 30 can be constantly maintained at full.

Further, a circulating path 39 having a conveying drive source 39a (e.g. pump means) makes a connection between the outlet 32 and the inlet 31 of the hot water storage tank 3. In such circumstances, when the conveying drive source 39a is driven, the water or the hot water in the hot water storage tank 3 is discharged from the outlet 32 of the hot water storage tank 3 and flows within a circulation path 39. Further, when the water or the hot water pass through a heat exchange path 72b of the heat exchange device 72 of the circulation path 39, the temperature of the water or the hot water is increased by means of a heat exchange between the heat exchange path 72b and the heat exchange path 72a of the coolant path 70, and then the heated water returns through the inlet 31 of the hot water storage tank 3 into the hot water storage chamber 30. In this way, the temperature of the hot water in the hot water storage chamber 30 of the hot water storage tank 3 can be increased, and thus the heat energy generated by the power generating operation of the fuel cell 1 has been stored as hot water in the hot water storage tank 3. Further, the inlet 31 of the hot water storage tank 3 is provided on the upper portion of the hot water storage tank 3, and the water feeding inlet 33 is provided on the lower portion in the hot water storage tank 2. In such structure, high-temperature water gathers to the upper portion of the hot water storage chamber 30, and low-temperature hot water gathers to the lower portion in the hot water storage chamber 30. Further, in the hot water storage chamber 30, plural temperature sensors 300 are provided inside the hot eater storage chamber 30 in order to detect the temperature of the water or the hot water stored in the hot water storage chamber 30. The temperature sensors 300 are positioned in a height direction of the hot water storage chamber 30. Signals from the plural temperature sensors 300 are input into each of the control portions 50 shown in FIG. 1, and thus, the control portion 5 can recognize the capacity of each of the hot water storage tank 3 in which energy can be stored as hot water.

As mentioned above, the heat energy storage capacity in the hot water storage tank 3 means a amount of the heat energy, which can be stored as hot water in the hot water storage chamber 30 of the hot water storage tank 3. Thus, the large amount of the heat energy storage capacity means that the temperature of the hot water in the hot water storage tank 3 is low, and also means that the capacity of the hot water storage chamber 30 of the hot water storage tank 3, in which the heat energy can be stored as hot water, is large. On the other hand, the small amount of the heat energy storage capacity of the hot water storage tank 3 means that the capacity of the hot water storage chamber 30 of the hot water storage tank 3, in which the heat energy can be stored as hot water, is small, in other words, that means that the temperature of the hot water in the hot water storage tank 3 has been already high.

In this system, “Wload” represents a total loading dose applied to all the fuel cells 1, and “N” represents the number of the fuel cells 1 that has been generating power (installed number of fuel cells 1). The control portion 5 calculates a standard generated power output Wa per cell by dividing Wload by N (Wload/N), and further the control portion 5 executes a power generation correcting process for correcting the standard generated power output Wa in accordance with the heat energy storage capacity of the hot water storage tank 3. Further, by means of a power meter 4× (total load detecting means) provided on the electric supply line 4, the total loading dose Wload applied to the total fuel cell 1 can be detected. A power meter may be provided in each of the housings 8 so as to obtain the total loading dose Wload by summing up each of the loading dose in each of the housings 8.

In the power generation correcting process, when a heat energy in a certain hot water storage tank 3 is relatively larger than heat energies in the other hot water storage tanks 3, specifically, a temperature of hot water stored in the certain hot water storage tank 2 is higher than the temperatures in the other hot water storage tanks 3, a power generating operation of the fuel cell 1, which outputs the heat energy to the certain hot water storage tank 3, is stopped, or the amount of the generated power output of the fuel cell 1, which outputs the heat energy to the certain hot water storage tank 3, is reduced.

Thus, when an amount of heat energy stored in a certain hot water storage tank 3 is relatively larger than heat energies stored in the other hot water storage tanks 3, in other words, when a heat energy storage capacity in the certain hot water storage tank 3 is smaller than the other heat energy storage capacities, the amount of the heat energy that can be further stored in the certain hot water storage tank 3 is small, and thus the power generating operation of the fuel cell 1, which outputs the heat energy to the certain hot water storage tank 3, is stopped, or the amount of the output of the power generation of the fuel cell 1, which outputs the heat energy to the certain hot water storage tank 3, is reduced. Thus, dispersion among the heat energies in the hot water storage tanks 3 can be reduced.

According to the embodiment, in order to stop the power generating operation of the fuel cell 1, the switching valve 60 of the fuel pipe 6 is closed, or the air conveying source 63 of the air pipe 62 is stopped. Further, in order to reduce the amount of the power generating operation of the fuel cell 1, an area of the opening of the switching valve 60 of the fuel pipe 60 is reduced, or the actuation amount of the air conveying source 63 of the air pipe 62 is reduced.

A minimum generated power output Wmin of the fuel cell 1 indicates a level of the output of the power generation, specifically, when the power generating operation has been executed by the fuel cell 1 at below the minimum generated power output Wmin, a power generation efficiency of the fuel cell 1 is significantly reduced. Thus, it is preferable that the power generating operation of the fuel cell 1 is executed so as to obtain the generated power output that is equal to or more than the minimum generated power output Wmin. In the power generation correcting process, if there is a fuel cell 1, in which the standard generated power output Wa is less than the minimum generated power output Wmin, the control portion 5 stops a power generating operation of at least one of the fuel cells 1 so as to reduces the number N of the fuel cells 1 that has been operated to generate power. Thus, the power generation of the fuel cell 1 is operated so as to obtain the generated power output that is greater than the minimum generated power output Wmin of the fuel cell 1. In such case, it is prevented that the power generation of the fuel cell 1 is operated at below the minimum generated power output Wmin, and thus protectivity and durability of the fuel cell 1 can be secured.

As mentioned above, when the standard generated power output Wa of the fuel cells 1 is set by dividing Wload by N, a fuel cell 1, in which the standard generated power output Wa is less than the minimum generated power output Wmin (Wa<Wmin), may exist. In such case, the amount of the generated power output generated in the fuel cell 1 (Wa<Wmin) is set to be greater than the minimum generated power output Wmin. Thus, even when a fuel cell 1, in which the standard generated power output Wa is less than the minimum generated power output Wmin (Wa<Wmin), has existed, the power generation is operated in circumstances where the generated power output of fuel cell 1 is set to be greater than the minimum generated power output Wmin, as a result significant decrease in a power generation efficiency of the fuel cell 1 can be prevented.

Thus, even when a fuel cell 1, in which the standard generated power output Wa is less than the minimum generated power output Wmin, has existed, the level of the power generation of fuel cell 1 is compulsory set to be greater than the minimum generated power output Wmin. As a result, it is possible that the total generated power output generated in this system exceeds a level of the electric energy that is required in this system. Thus, in order to prevent such excess on the total generated power output, the amount of the generated power outputs of all fuel cells 1, other than the concerned fuel cell 1, is reduced, and thus the excessive amount has been offset. In this case, it is preferable that the generated power outputs in all the fuel cells 1 except the concerned fuel cell 1 (fuel cells 1: Wa>Wmin) are equally reduced. Thus, the generated power outputs of each of the fuel cells 1, which operates power generation, can be equalized, and the excess on the total generated power output can be prevented.

Further, it is preferable that the power generation is operated below the declared power output Wmax. According to the present embodiment, in the power generation correcting process, when a fuel cell 1, in which the standard generated power output Wa is more than the declared power output Wmax (Wa>Wmax), has existed, the control portion 5 reduces a generated power output of the concerned fuel cell (Wa>Wmax) in order to prevent that the generated power output becomes above the declared power output Wmax. Thus, even when a fuel cell 1, in which the standard generated power output Wa is more than the declared power output Wmax (Wa>Wmax), has existed, the control portion 5 reduces the generated power output of the concerned fuel cell (Wa>Wmax) in order to prevent that the generated power output becomes above the declared power output Wmax, and thus, protectivity and durability of the fuel cell 1 can been enhanced.

Further, even when a fuel cell 1, in which the standard generated power output Wa is more than the declared power output Wmax (Wa>Wmax), has existed, the control portion 5 forces to reduce a generated power output of the concerned fuel cell (Wa>Wmax) in order to prevent that the generated power output becomes above the declared power output Wmax, as a result the total generated power output generated by means of the present system may become short. Thus, in order to prevent such short on the total generated power output, in the power generation correcting process, the amount of the generated power outputs of the other fuel cells 1, in which the standard generated power output Wa have not exceeded the declared power output Wmax, are increased. In this case, it is preferable that the generated power outputs of all the fuel cells 1 other than the concerned fuel cell 1 are equally increased. Thus, the generated power outputs of each of the fuel cells 1, which has been operated to generate power, can be equalized, and the short on the total generated power output can be prevented.

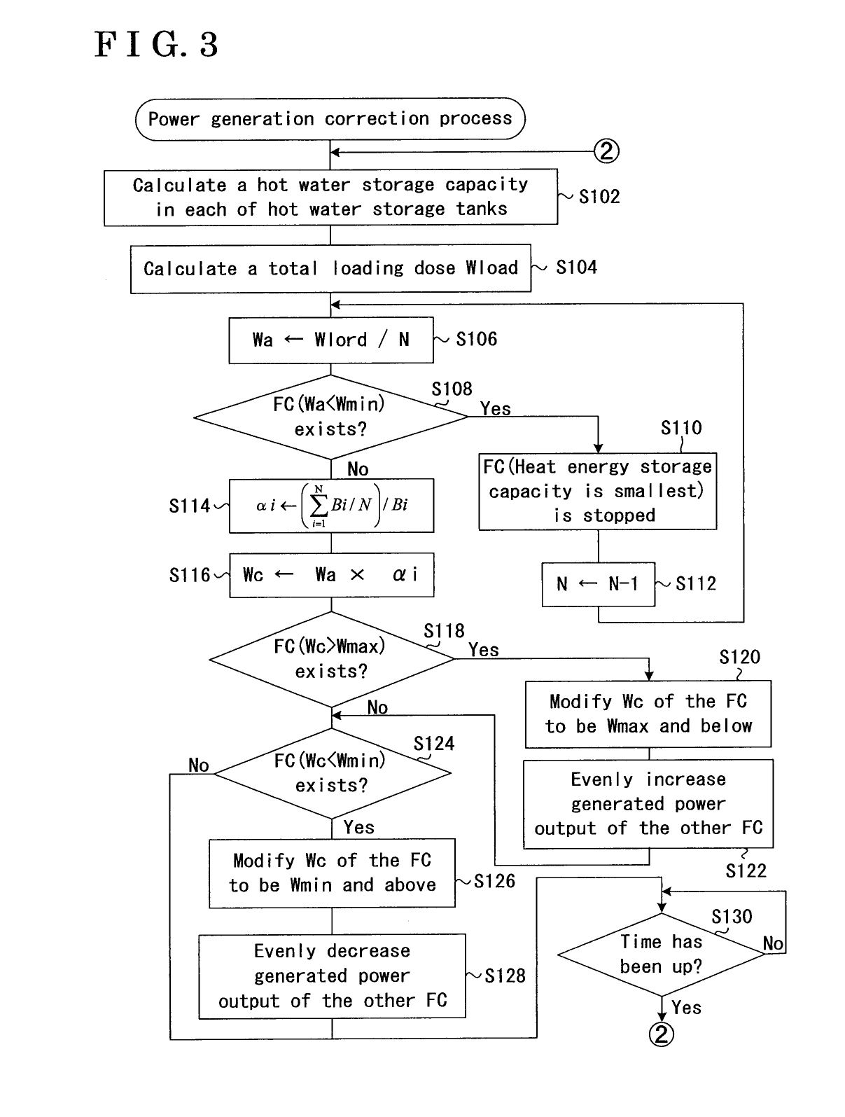

FIG. 3 illustrates a typical control of the power generation correcting process (power generation correcting means) executed by the control portion 5 according to the present embodiment. The power generation correcting process executed by the control portion 5 is not limited to such control illustrated in a flow chart in FIG. 3, and the power generation correcting process may be altered.

As shown in FIG. 3, in a step S102, a heat energy storage capacity in each of the hot water storage tanks 3 (the amount of the heat energy that can be further stored as hot water in each of the hot water storage tanks) is calculated. Each of the hot water storage tanks 3 corresponds to each of the fuel cells 1 used for each of the housings 8. Then, the process goes to a step S104. In the step S104, a total loading dose Wload applied to all the fuel cells 1 (total electric energies required for all the housings 8) is calculated. The total loading dose Wload can be obtained by summing up all the electric energies consumed at all the housings 8.

Then, the process goes to a step S106. In the step S106, when a total number of the fuel cells 1, which has been operated to generate power, is set to N, the control portion 5 set a value, which is calculated by dividing the total loading dose Wload by N, to the standard generated power output Wa per cell. Thus, the control portion 5 controls the power generating operation on each of the fuel cell 1 so that, basically, the power generation thereof becomes the standard generated power output Wa.

Then, the process goes to a step S108. In the step S108, it is determined whether or not there is a fuel cell 1, in which the standard generated power output Wa is less than the minimum generated power output Wmin, has existed. In FIG. 3, FC indicates a fuel cell. If there is at least one fuel cell 1, in which the standard generated power output Wa is less than the minimum generated power output Wmin, the process goes to a step S110. In the step S110, the power generating operation of a fuel cell 1, whose temperature of the hot water in the hot water storage chamber 30 is high, in other words, whose heat energy storage capacity is smallest in the group of the fuel cells 1, has been stopped because of that the temperature of the hot water stored in such hot water storage tank 3, whose heat energy storage capacity is smallest in the group, has been considerably high, and such tank has a small capacity in which heat energy can be stored as hot water. Then, the process goes to a step S112. In the step S112, 1 is subtracted from N of the counted number of the fuel cells 1, which has been operated to generate power, and then the process goes back to the step S106.

From the step S106 through the step S112 are repeated until it is determined that there is no fuel cell 1, in which the standard generated power output Wa is less than the minimum generated power output Wmin in S108.

If it is determined that there is no fuel cell 1, in which the standard generated power output Wa is less than the minimum generated power output W min, the process goes to a step S114. In the step S114, a heat energy storage capacity parameter α i of each of the hot water storage tanks 3 is calculated. Specifically, the heat energy storage capacity parameter α i means a proportion of the capacity in the storage tank 3, in which hot water can be stored as heat energy. The heat energy storage capacity parameter α i can be calculated as follow.

First, a total of the heat energies Bi, which is obtained on the basis of the amount of the hot water whose temperature is greater than a predetermined temperature, is calculated. Specifically, such hot water (heat energy) is stored in the hot water storage tanks 3 of fuel cell 1, which has been operated to generate power. Then, the total of the heat energies Bi is divided by the counted number N, which is the number of the fuel cells 1 that have been operated to generate power, and thus an average value Bave of the heat energy in each of the hot water storage tanks 3 can be obtained. The total of the heat energies Bi can be obtained, if necessary, on the basis of the total amount of the heat energy in all the hot water storage tanks 3 in the group.

Further, a proportion of the calculated average value Bave relative to the heat energy Bi, on the basis of the hot water storage amount stored in the specific hot water storage tank 3, is calculated by dividing Bave by Bi, and the calculated value is a heat energy storage capacity parameter α i of the specific hot water storage tank 3.

For example, when the value α i is 1, the heat energy storage capacity in the specific hot water storage tank 3 equals to the average value of the heat energy storage capacity among the hot water storage tanks 3 of the fuel cells 1, which have been operated to generate power. When the value α i is less than 1, the heat energy storage capacity in the specific hot water storage tank 3 is smaller than the average value of the heat energy storage capacity among the hot water storage tanks 3 of the fuel cells 1, which have been operated to generate power, which means the capacity in the specific hot water storage tank 3, in which heat energy can be stored, is relatively small. Further, if the value α i is greater than 1, the heat energy storage capacity in the specific hot water storage tank 3 is larger than the average value of the heat energy storage capacity among the hot water storage tanks 3 of the fuel cells 1, which have been operated to generate power, which means the capacity in the specific hot water storage tank 3, in which heat energy can be stored, is relatively large.

Then, the process goes to a step S116. In the step S116, a corrected generated power output Wc of each of the fuel cells 1 is calculated by multiplying the standard generated power output Wa by the heat energy storage capacity parameter α i. Thus, when the value of the heat energy that can be stored as hot water in the hot water storage tank 3 is large, the generated power output of the fuel cell 1, which stores the heat energy in the hot storage tank 3, is increased. On the other hand, when the value of the heat energy that can be stored as hot water in the hot water storage tank 3 is small, the generated power output of the fuel cell 1, which stores the heat energy in the hot storage tank 3, is decreased.

Further, the process goes to a step S118. Because it is preferable that the fuel cell 1 is operated so as to generate power at equal to or less than the declared power output Wmax in order to enhance its protectivity and durability, in the step 118, it is determined whether or not the corrected generated power output We is above the declared power output Wmax. If there is a fuel cell 1 whose corrected generated power output We is above the declared power output Wmax, the process goes to a step S120. In the step S120, the generated power output of the fuel cell 1, whose corrected generated power output We is above the declared power output Wmax, is reduced compulsorily so as to modify the generated power output of the fuel cell to be equal to or less than the declared power output Wmax. Thus, it is prevented that the generated power output of the fuel cell 1 becomes above the declared power output Wmax, as a result, the protectivity and durability of the fuel cell 1 can be enhanced.

Even when there is a fuel cell 1 whose corrected generated power output Wc is above the declared power output Wmax, because the generated power output of the fuel cell 1 is compulsorily decreased, the total generated power output may run short by the reduced value.

Thus, the generated power outputs of other fuel cells 1, whose corrected generated power outputs Wc are not above the declared power output Wmax, are evenly increased. Specifically, the generated power output is evenly increased by a value that is calculated by dividing δ 1, which is the value of a total shorted power generation, by N, which is the number of the fuel cells 1 operated to generate power. In this way, it is prevented that the power generating operation of the fuel cell 1 becomes above the declared power output Wmax, and further it is prevented that the total generated power output of this system run short.

In addition, as mentioned above, it is preferable that the fuel cell 1 executes the power generating operation so as to be equal to or more than the minimum generated power output Wmin. Thus, the process goes to a step S124 and determines whether or not there is a fuel cell 1 whose corrected generated power output Wc is below the minimum generated power output Wmin.

If it is determined that there is a fuel cell 1 whose corrected generated power output Wc is below the minimum generated power output Wmin, the process goes to a step S126.

In the step S126, the generated power output of the fuel cell 1, whose corrected generated power output We is below the minimum generated power output Wmin, is increased compulsorily so as to modify the generated power output of the fuel cell to be equal to or more than the minimum generated power output Wmin. Thus, it is prevented that the generated power output of the fuel cell 1 becomes below the minimum generated power output Wmin, as a result, the protectivity and durability on the fuel cell 1 can be enhanced.

Further, because the generated power output of the fuel cell 1 is compulsorily increased, the total generated power output may become excess by the increased value. Thus, in a step S128, the generated power outputs of other fuel cells 1, whose corrected generated power outputs Wc are above the minimum generated power output Wmin, are evenly decreased. Specifically, the generated power outputs are evenly decreased by a value that is calculated by dividing δ 2, which is an amount of a total excess power generation, by N, which is the number of the fuel cells 1 operated to generate power. In this way, it is prevented that the power generating operation of the fuel cell 1 becomes below the minimum generated power output Wmin, and further it is prevented that the total generated power output of this system get excess. Then, the process goes to a step S130. In the step S130, it is determined whether or not a predetermined time has been up. If the time has been up, the process returns to the step S102. In this process, the corrected generated power output Wc has been calculated by multiplying the standard generated power output Wa by the heat energy storage capacity parameter α i. However, the above calculated value may be further multiplied by a coefficient β in order to calculate the corrected generated power output Wc.

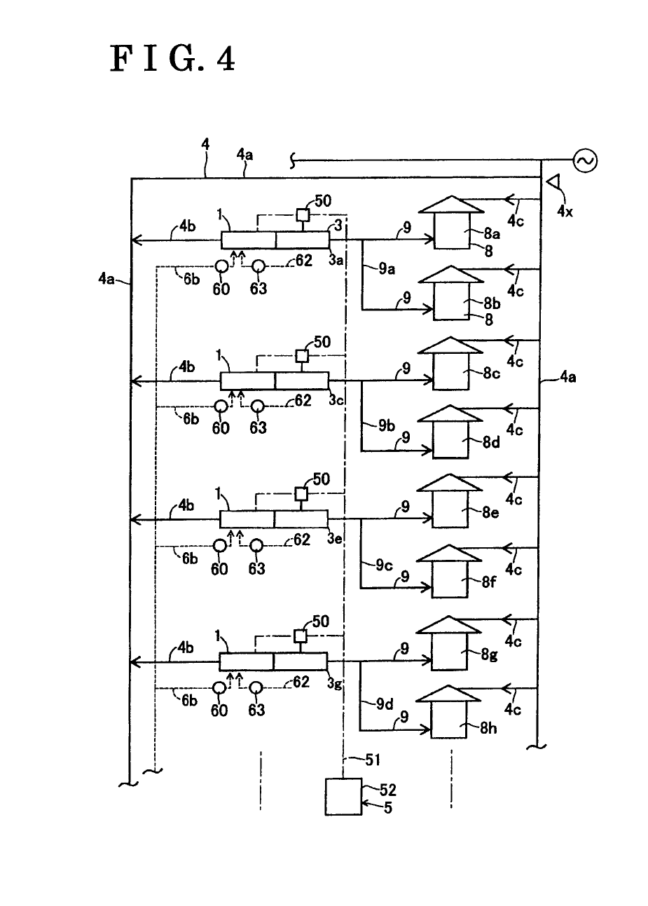

FIG. 4 illustrates a second embodiment according to the present invention. The second embodiment basically has a similar structure, operation and effect to those of the first embodiment, and the second embodiment will be explained with reference to FIG. 4. The emphasis will be placed on an explanation of differences from the first embodiment.

In the first embodiment, each of the housings 8 (8a, 8b, 8c, 8d, 8e, 8f, 8g, 8h . . . ) equips the fuel cell 1 and the hot water storage tank 3. However, in the second embodiment, the housings 8 (8a, 8b, 8c, 8d, 8e, 8f, 8g, 8h . . . ) are divided into small groups so that, for example, two housings 8 get together, and each of the groups equips one fuel cell 1 and one hot water storage tank 3. A modifying device may be attached to the fuel cell 1 in order to modify utility gas into reformed gas, and the reformed gas may be supplied to the fuel cell 1.

Thus, according to the present invention, the fuel cell power generation system can improve its practicality by means of a simple control, instead of a linear programming.

Further, according to the present invention, when a heat energy storage capacity of a hot water storage tank is relatively smaller than the other hot water storage tanks, the number of the fuel cell can be decreased by stopping the power generating operation of a fuel cell which stores heat energy in the above hot water storage tank, or the amount of an generated power output of the fuel cell which stores heat energy in the above hot water storage tank can be decreased. Thus, it can be prevented that the heat energy is stored in the hot water storage tank, whose heat energy storage capacity is small. As a result, it can be prevented that the hot water storage tank, whose heat energy storage capacity is small, is excessively heated. Thus, differences of the amounts of the heat energy stored as hot water in each of the hot water storage tanks can be reduced.

Further, according to the present invention, the heat energy storage capacity means a capacity of the hot water storage tank in which the heat energy can be stored as hot water. The large amount of the heat energy storage capacity of the hot water storage tank means that the capacity of the hot water storage tank, in which the heat energy can be stored as hot water, is large. On the other hand, the small amount of the heat energy storage capacity of the hot water storage tank means that the capacity of the hot water storage tank, in which the heat energy can be stored as hot water, is small.

Further, according to the present invention, when there is at least one of the fuel cells, in which the standard generated power output Wa is below a minimum generated power output, the control portion stops the power generating operation of at least one of the fuel cells in order to decrease the number of the fuel cells which has operated to generate power. The minimum generated power output is set in advance to each of the fuel cells, and if the fuel cell generate power is below the minimum generated power output, the power generation efficiency on the fuel cell is significantly decreased. Thus, it is required that the power generating operation is executed at greater than the minimum generated power output.

Further, according to the present invention, when there is at least one of the fuel cells, in which the standard generated power output Wa is below the minimum generated power output, the control portion set the generated power output of the fuel cell so as to be greater than the minimum generated power output, at the same time, the control portion reduces the generated power outputs of the other fuel cells.

Thus, even when a fuel cell, in which the standard generated power output Wa is less than the minimum generated power output has existed, the control portion set the generated power output of the fuel cell so as to be greater than the minimum generated power output, and thus it can be prevented that the power generation efficiency on the fuel cell is significantly reduced.

Further, even when a fuel cell, in which the standard generated power output Wa is less than the minimum generated power output, has existed, because the control portion set the generated power output of the fuel cell so as to be greater than the minimum generated power output, as a result, the total generated power output may be excess, however, the generated power outputs of the other fuel cells are reduced so as to prevent the excess on the total generated power output.

Further, according to the present invention, when a fuel cell, in which the standard generated power output Wa is above the declared power output, has existed, it is preferable that the control portion prevents that the generated power output becomes above the declared power output, at the same time, the control portion increases the generated power outputs of the other fuel cells.

Thus, even when a fuel cell, in which the standard generated power output Wa is above the declared power output, has existed, because it can be prevented that the generated power output of the fuel cell becomes above the declared power output, protectivity and durability on the fuel cells can be enhanced.

Further, even when a fuel cell, in which the standard generated power output Wa is above the declared power output, has existed, because it can be prevented that the generated power output of the fuel cell becomes above the declared power output, the generated power outputs of the other fuel cells is increased so as to prevent that the total generated power output runs short. Thus, the total generated power output of the fuel cells can be secured.

Further, according to the present invention, when there is a fuel cell, in which the corrected generated power output Wc, which is obtained by correcting the standard generated power output Wa in accordance with the heat energy storage capacity, is less than the minimum generated power output, the control portion stops the power generating operation of at least one of the fuel cells so as to decrease the number of the fuel cells, which is operated to generate power. A minimum generated power output of the fuel cell indicates a level of the output of the power generation. Specifically, when the power generating operation has been executed by the fuel cell at below the minimum generated power output, a power generation efficiency of the fuel cell is significantly reduced. Thus, it is required that the power generating operation of the fuel cell is executed so as to obtain the generated power output so as to be equal to or more than the minimum generated power output.

Further, according to the present invention, when there is a fuel cell whose corrected generated power output Wc, which is obtained by correcting the standard generated power output Wa in accordance with the heat energy storage capacity, is less than the minimum generated power output, the control portion set the generated power output so as to be equal to or more than the minimum generated power output, at the same time, the control portion reduces the power generating outputs of the other fuel cells.

Thus, even when there is a fuel cell whose corrected generated power output We is less than the minimum generated power output, because the control portion set the generated power output so as to be equal to or more than the minimum generated power output, it can be prevented that the power generation efficiency of the fuel cell is significantly reduced.

Further, even when there is a fuel cell whose corrected generated power output We is less than the minimum generated power output, because the control portion set the generated power output so as to be equal to or more than the minimum generated power output, the total generated power output may be excess, however, the generated power outputs of the other fuel cells can be reduced in order to prevent that the total generated power output becomes excess. Thus, excess on the total generated power output of the fuel cells can be prevented.

Further, according to the present invention, when a fuel cell whose corrected generated power output We becomes above the declared power output, it is prevented that the generated power output of the fuel cell becomes above the declared power output, at the same time, the generated power outputs of the other fuel cells, whose corrected generated power outputs We are not above the declared power output, are increased. Thus, even when a fuel cell whose corrected generated power output We is above the declared power output, it can be prevented that the generated power output of the fuel cell becomes above the declared power output, as a result, protectivity and durability on the fuel cells can be enhanced. Further, even when a fuel cell whose corrected generated power output We is above the declared power output, because it is prevented that the generated power output of the fuel cell becomes above the declared power output, the generated power outputs of the other fuel cells are increased so as to prevent that the total generated power output runs short. Thus, the total generated power output of the fuel cells can be secured.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An operation method of a fuel cell power generation system including plural fuel cells executing power generating operations by use of oxidants and fuel, plural hot water storage tanks in which heat energies generated upon the power generating operations of the fuel cells is stored as hot water, a power supplying portion supplying electric energies generated by the fuel cells to plural electric energy consuming portions and a control portion controlling the power generating operations executed by the fuel cells, the method comprising:
calculating a standard generated power output Wa per one fuel cell by dividing Wload, which is a total loading dose applied to all the fuel cells, by N, which is a total number of the fuel cells that are operated to generate power;
correcting the standard generated power output Wa of the fuel cells that are operated to generate power on a basis of a heat energy storage capacity of each of the hot water storage tanks corresponding to the fuel cells that are operated to generate power; and
controlling each of the fuel cells that are operated to generate power on a basis of the corresponding corrected Wa.

2. The operation method according to claim 1, wherein when a heat energy storage capacity of a first hot water storage tank is relatively smaller than each of the heat energy storage capacities of other hot water storage tanks, the method further comprises:
stopping a power generating operation of a first fuel cell, which stores the heat energy in the first hot water storage tank, or decreasing a level of a generated power output of the first fuel cell, which stores the heat energy in the first hot water storage tank.

3. The operation method according to claim 2, further comprising:
increasing generated power outputs of all fuel cells other than the first fuel cell, whose power generating operation is stopped or whose level of the generated power output is decreased.

4. The operation method according to claim 3, further comprising:
evenly increasing the generated power outputs of the fuel cells other than the first fuel cell.

5. The operation method according to claim 1, further comprising:
stopping a power generating operation of at least one of the fuel cells to decrease the total number N of the fuel cells when a fuel cell exists in which the level of standard generated power output Wa is less than a level of a minimum generated power output.

6. The operation method according to claim 5, further comprising:
increasing generated power outputs of all the fuel cells other than the fuel cell, whose power generating operation is stopped.

7. The operation method according to claim 6, further comprising:
evenly increasing the levels of the generated power outputs of the fuel cells.

8. The operation method according to claim 1, further comprising:
stopping a power generating operation of the first fuel cell to decrease the total number N of the fuel cells when a fuel cell exists in which a level of the standard generated power output Wa is less than a level of a minimum generated power output.

9. The operation method according to claim 8, further comprising:
increasing generated power outputs of all the fuel cells other than the first fuel cell, whose power generating operation is stopped.

10. The operation method according to claim 9, further comprising:
evenly increasing the levels of the generated power outputs of the fuel cells other than the first fuel cell.

11. The operation method according to claim 1, when there is a first fuel cell whose corrected generated power output Wc, which is corrected depending on the heat energy storage capacity, is less than its minimum generated power output, the method further comprises:
setting a generated power output of the first fuel cell so as to be equal to or more than its minimum generated power output; and
decreasing levels of generated power outputs of the other fuel cells.

12. The operation method according to claim 11, further comprising:
evenly decreasing the levels of the generated power outputs of the other fuel cells are evenly decreased.

13. The operation method according to claim 1, when there is a first fuel cell whose corrected generated power output Wc, which is corrected depending on the heat energy storage capacity, is above a declared power output, the method further comprises:
preventing the generated power output of the first fuel cell from becoming greater than a declared power output; and
increasing levels of generated power outputs of the other fuel cells, whose corrected generated power outputs Wc are not above the declared power output.

14. The operation method according to claim 13, further comprising:
evenly increasing the levels of the generated power outputs of the other fuel cells.

15. The operation method according to claim 1, further comprising:
calculating corrected generated power outputs Wc by multiplying the standard generated power output Wa by a heat energy storage capacity parameter, which is calculated by dividing an average heat energy storage capacity of all the hot water storage tanks by the heat energy storage capacity of each of the hot water storage tanks.

16. The operation method according to claim 1, wherein the energy consuming portion is a housing.

17. The operation method according to claim 1, wherein the energy consuming portions are a complex housing or houses in block.

18. The operation method according to claim 1, further comprising:
supplying the heat energy stored in at least one of the hot water storage tanks to the electric energy consuming portions.

19. The operation method according to claim 1, further comprising:
sharing the heat energies stored in at least two of the hot water storage tanks with the electric energy consuming portions.

20. The operation method according to claim 1, further comprising:
attaching modifying devices to the fuel cells in order to modify utility gas into reformed gas; and
supplying the reformed gas to the fuel cells.
